(19) United States
(12) Patent Application Publication
(10) Pub. No.: US 2005/0134129 A1
(43) Pub. Date: Jun. 23, 2005

(54) Motor housing

(76) Inventors: Hiroyuki Sato, Oobu-city (JP); Hiroshi Nakajima, Anjou-city (JP); Katsuji Kuwada, Chita-gun (JP)

Correspondence Address: HARNESS, DICKEY & PIERCE, P.L.C., P.O. BOX 828, BLOOMFIELD HILLS, MI, 48303, US

(21) Appl. No.: 11/014,573

(22) Filed: Dec. 16, 2004

(30) Foreign Application Priority Data
Dec. 17, 2003 (JP) 2003-419564

(51) Int. Cl. H02K 9/00; H02K 5/10

(52) U.S. Cl. 310/88; 310/58; 310/89

(57) ABSTRACT

In a motor housing, an upper case and lower case are engaged with each other in the upward and downward direction at the respective engaging portions, and a motor etc. is accommodated in the housing. At a lower end portion of the outer surface of the upper case, an umbrella-shaped portion is protruded laterally, and a gap is provided between the umbrella-shaped portion and the side of the lower case. At a lower end portion of the umbrella-shaped portion, a dripping end portion, from which water drips down, is formed at a lower position than that of the lower face of the lower case. Thereby, water, which has dripped down on the outer surface of the upper case to the dripping end portion, cannot move to the engaging end portion side formed on the side of the lower case. Accordingly, the intrusion of water can be prevented.

### BACKGROUND OF THE INVENTION

1. Field of the Invention

The present invention relates to a motor housing for accommodating a motor of a blower used for air conditioning.

2. Description of the Related Art

Conventionally a blower motor used for air conditioning is accommodated in a housing formed when an upper case and a lower case are engaged with each other. In this structure, the housing can be divided into the upper and the lower case. Air sent from the blower flows in the motor housing to an air conditioning unit arranged on the downstream side of the motor housing.

FIGS. 3A and 3B are sectional views of an engaging portion, in which the upper case 1 and the lower case 2 are engaged with each other, of the prior art. In this connection, the direction indicated by the arrow in the drawing shows the direction of the arrangement of the motor housing.

As shown in the drawings, according to the prior art, the engaging end portion S, which is the end portions of the engaging portions 11, 21 of the upper case 1 and the lower case 2, is exposed onto the upper surface 20 of the lower case 2.

Strictly speaking, the engaging portion 11 of the upper case 1 and the engaging portion 21 of the lower case 2 do not come into perfect-surface-contact with each other. In other words, most of the contacting portions between the engaging portions 11, 21 are point contact or surface contact, and the other portions between the engaging portions 11, 21 are not contacted with each other, that is, the other portions form gaps between the engaging portions 11, 21.

In an air conditioning unit for vehicle use, rain water or snow, which has entered inside a vehicle, drips on an outer surface of the motor housing. In the case where a cooling air is sent from the outside into the motor housing so that the motor can be cooled, the inside of the motor housing is maintained at a negative pressure by the influence of the cooling air flowing in the motor housing.

Accordingly, water dripping on the outer surface of the housing is sucked inside the housing from the gap between the upper case 1 and the lower case 2 by the capillary phenomenon, which is generated in the engaging end portion S of the upper case 1 and the lower case 2, and by the negative pressure in the housing.

For example, in the case of the housing shown in FIG. 3A, water dripping downward on the outer surface 10 of the upper case 1 reaches the engaging end portion S before the water flows to the outer surface 20 of the lower case 2. Therefore, the water is sucked from this engaging end portion S into the engaging portions 11, 21 by the action of the capillary phenomenon.

In the case of the housing shown in FIG. 3B, water dripping downward on the outer surface 10 of the upper case 1 reaches the lower end portion 10a of the outer surface 10 of the upper case 1. After that, the water moves in the lateral direction on the lower end surface of the outer surface 10 of the upper case 1 due to surface tension and reaches the engaging end portion S formed on the outer surface 20 of the lower case 2. In this case, the water is also sucked from the engaging end portion S into the engaging portions 11, 21 by the action of the capillary phenomenon.

The water sucked into the motor housing from the engaging end portion S via the engaging portions 11, 21 as described above enters the motor due to a current of cooling air flowing in the motor housing. Accordingly, there is a possibility that the motor will fail.

### SUMMARY OF THE INVENTION

In view of the above points, it is an object of the present invention to prevent water from moving into the motor housing.

In order to accomplish the above object, according to a first aspect of the present invention, a motor housing comprises an upper case (1) and a lower case (2) which are engaged with each other by the respective engaging portions (11, 21), the motor housing accommodating a motor (7, 7a) inside, wherein a positional relation between an engaging end portion (S) located on a side (20) which is an outer surface of the lower case in the upward and downward direction and a dripping end portion (P) located at a lower end portion (100, 101, 102, 103, 110, 111, 112, 113) of an outer surface of the upper case which is a portion from which water drips down on the upper surface of the upper case is established so that at least one of the distance (a) in the lateral direction perpendicular to the upward and downward direction from the dripping end portion and the side of the lower case and the distance (b) in the upward and downward direction from the dripping end portion to the engaging end portion is not less than a predetermined value.

An engaging end portion, which is an end portion formed on an outer surface of a lower case in the engaging portion of the upper and the lower case, can be a starting point of the capillary phenomenon. Therefore, according to the present invention, in the case where the upward and downward direction of a motor housing is arranged in the perpendicular direction, this engaging end portion and the water dripping end portion, which is a portion where water drips down while separated from the upper case, are located separated by a distance not less than a predetermined value. Therefore, water existing at the dripping end portion is prevented from moving to the engaging end portion. Accordingly, it is possible to prevent water from being sucked into the lower case via the engaging portion of the upper and the lower case from the engaging end portion by the capillary phenomenon, that is, it is possible to prevent water from being sucked into the motor housing.

According to a second aspect of the present invention, a skirt portion (100b, 100c, 105) having an opening, the length in the lateral direction of which is a predetermined value, is formed at the lower end portion of the upper case.

Due to the foregoing, water, which has dripped on the outer surface of the upper case and reaches a lower end portion of the upper case, is prevented from moving in the lateral direction by a skirt portion provided in the lower end portion of the upper case, that is, water, which has dripped on the outer surface of the upper case and reaches a lower end portion of the upper case, is prevented from moving to the outer surface of the lower case. Accordingly, it is difficult for water, which has flowed to the lower end portion of the upper case, to reach the engaging end portion formed on the outer surface of the lower case. While this lower end portion of the upper case is being used as a dripping end portion, water drips downward from this dripping end portion. Therefore, water can be prevented from moving into the motor housing from the engaging end portion by the capillary phenomenon.

According to a third aspect of the present invention, a protruding portion (100, 101, 102, 103) protruding in the opposite direction to the lower case is formed in the lower end portion of the upper case in the lateral direction, and the dripping end portion is located on a surface of the protruding portion.

Due to the foregoing, water, which is dripping down on the outer surface of the upper case, reaches a protruding portion surface of the lower end portion of the upper case protruding in the lateral direction onto the opposite side to the lower case. This water drips downward from the dripping end portion of the protruding portion surface before the water moves onto the outer surface of the lower case. Accordingly, water, which has reached the lower end portion of the upper case, cannot reach the engaging end portion formed on the outer surface of the lower case. Accordingly, water can be prevented from moving into the motor housing from the engaging end portion by the capillary phenomenon.

According to a fourth aspect of the present invention, an umbrella-shaped portion (102) extending in an oblique downward direction with respect to the upward and downward direction by a predetermined length is formed on an outer surface of the upper case on the opposite side to the lower case.

Due to the foregoing, water dripping on the outer surface of the upper case reaches a lower end portion of an umbrella-shaped portion, which is provided on the outer surface of the upper case, extending obliquely downward by a predetermined length. Before this water moves to the outer surface of the lower case, it drips downward from the lower end portion of the umbrella-shaped portion which functions as a dripping end portion. Accordingly, it is difficult for the water dripping down on the outer surface of the upper case to reach the engaging end portion formed on the upper surface of the lower case. Therefore, it is possible to prevent the water from moving into the motor housing from the engaging end portion by the capillary phenomenon.

According to a fifth aspect of the present invention, a tapered portion (112a), the distance in the lateral direction from the side of the lower case of which is increased as it comes in the downward direction, is formed in the lower end portion (112) of the upper case, and the dripping end portion is a lower end portion of the tapered portion in the upward and downward direction.

Due to the foregoing, water, which has dripped down on the outer surface of the upper case and reached the lower end portion of the upper case, drips downward from the lower end portion of the tapered portion provided in the lower end portion of the upper case, wherein this lower end portion of the tapered portion provided in the lower end portion of the upper case functions as a dripping end portion. As a distance in the lateral direction from the dripping end portion of the tapered portion to the side of the lower case is large, water is prevented from moving from this dripping end portion to the side of the lower case. Accordingly, it is difficult for the water, which has reached the lower end portion of the upper case, to flow to the engaging end portion formed on the outer surface of the lower case. Therefore, the water drips from this lower end portion of the upper case, wherein this lower end portion of the upper case functions as a dripping end portion. Accordingly, it is possible to prevent the water from moving into the motor housing due to the capillary phenomenon.

According to a sixth aspect of the present invention, a lower end portion (T) of the side (20) of the lower case in the upward and downward direction is located at an upper position of the lower surface (22) of the lower case in the upward and downward direction.

Due to the foregoing, even when water exists on the lower surface of the lower case in the upward and downward direction, the water can be prevented from moving to the lower end portion of the side of the lower case which is located in an upper portion of the surface of the lower side. Accordingly, for example, even in the case where the lower end portion of the lower case side is used as an engaging end portion, water cannot move to this engaging end portion. Therefore, it is possible to prevent water from moving into the motor housing from the engaging end portion by the phenomenon of capillary phenomenon.

According to a seventh aspect of the present invention, a gap (100b, 100c, 105) of a predetermined length (α) is formed in the lateral direction between the lower end portion of the upper case and the side of the lower case.

Due to the foregoing, water, which has dripped down on the outer surface of the upper case and reached the lower end portion of the upper case, is prevented from moving in the lateral direction by a gap, of a predetermined length, which is formed in the lateral direction between the lower end portion of the upper case and the side of the lower case, that is, water, which has dripped down on the outer surface of the upper case and reached the lower end portion of the upper case, is prevented from moving to the outer surface of the lower case. Accordingly, the water, which has reached the lower end portion of the upper case, cannot reach the engaging end portion, which is formed on the outer surface of the lower case, and drips downward from the lower end portion of the upper case, wherein the lower end portion of the upper case functions as a dripping end portion. Therefore, it is possible to prevent water from moving into the motor housing from the engaging end portion by the capillary phenomenon.

As shown in the eighth aspect, the distance from the dripping end portion to the side of the lower case in the lateral direction can be a predetermined value of 1 mm. That is, when the dripping end portion provided on the upper case is located at a position distant from the outer surface of the lower case, on which the engaging end portion is formed, in the lateral direction by 1 mm, the water, which has dripped on the outer surface of the upper case to the dripping end portion, is prevented from moving to the side of the lower case because the distance in the lateral direction is too large.

According to a ninth aspect of the present invention, the dripping end portion is located at a lower position of the engaging end portion in the upward and downward direction.

Due to the foregoing, the water, which has dripped downward on the outer surface of the upper case and reached the dripping end portion of the lower end of the upper case, is prevented from moving from the dripping end portion in the upward and downward direction, that is, the water is prevented from moving to the engaging end portion located in the upper portion in the perpendicular direction. Therefore, the water drips downward from the dripping end portion in the perpendicular direction. Accordingly, water can be prevented from moving into the engaging end portion by the capillary phenomenon.

As shown in the tenth aspect, when the lower end portion, itself, of the upper case is located at a lower position on the lower end portion of the side of the lower case, the water, which has dripped downward on the outer surface of the upper case and reached the lower end portion of the upper case, can be prevented from moving to an upper portion of the lower end portion of the upper case, that is, the water, which has dripped downward on the outer surface of the upper case and reached the lower end portion of the upper case, can be prevented from moving to the lower end portion of the side of the lower case which is located at an upper position of the lower end portion of the upper case. Accordingly, water can be prevented from moving to the engaging end portion formed on the side of the lower case. Accordingly, it is possible to prevent water from moving into the engaging end portion by the capillary phenomenon.

Further, when a drain hole (2b) is formed in a lower side bottom portion (2a) of the lower case in the upward and downward direction as shown in the eleventh aspect, water, which has soaked into the housing, can be discharged from the housing from this drain hole to the outside of the housing.

According to a twelfth aspect of the present invention, cooling air flows into the motor housing.

Incidentally, the reference numerals in parentheses, to denote the above means, are intended to show the relationship of the specific means which will be described later in an embodiment of the invention.

The present invention may be more fully understood from the description of preferred embodiments of the invention set forth below, together with the accompanying drawings.

### BRIEF DESCRIPTION OF THE DRAWINGS

In the drawings:

FIG. 1 is an upper view showing a motor housing of an embodiment of the present invention;

FIG. 2 is a partially sectional view and side view of FIG. 1;

FIGS. 3A and 3B are sectional views showing an engaging portion of an upper case and a lower case of the prior art;

FIG. 4 is a sectional view showing an engaging portion of an upper case and a lower case of the first embodiment;

FIG. 5 is a diagram showing a relation between the maximum gap α of a skirt portion (gap) of a lower end portion of an upper case and the generation of the capillary phenomenon by which water is sucked;

FIG. 6 is a sectional view showing an engaging portion of an upper case and a lower case of the second embodiment;

FIG. 7 is a sectional view showing an engaging portion of an upper case and a lower case of the third embodiment;

FIG. 8 is a sectional view showing an engaging portion of an upper case and a lower case of the fourth embodiment;

FIG. 9 is a sectional view showing an engaging portion of an upper case and a lower case of the fifth embodiment;

FIG. 10 is a sectional view showing an engaging portion of an upper case and a lower case of the sixth embodiment;

FIG. 11 is a sectional view showing an engaging portion of an upper case and a lower case of the seventh embodiment;

FIG. 12 is a sectional view showing an engaging portion of an upper case and a lower case of the eighth embodiment;

FIG. 13 is a sectional view showing an engaging portion of an upper case and a lower case of another embodiment;

FIG. 14 is a sectional view showing an engaging portion of an upper case and a lower case of still another embodiment; and

FIG. 15 is a sectional view showing an engaging portion of an upper case and a lower case of still another embodiment.

### DESCRIPTION OF PREFERRED EMBODIMENTS

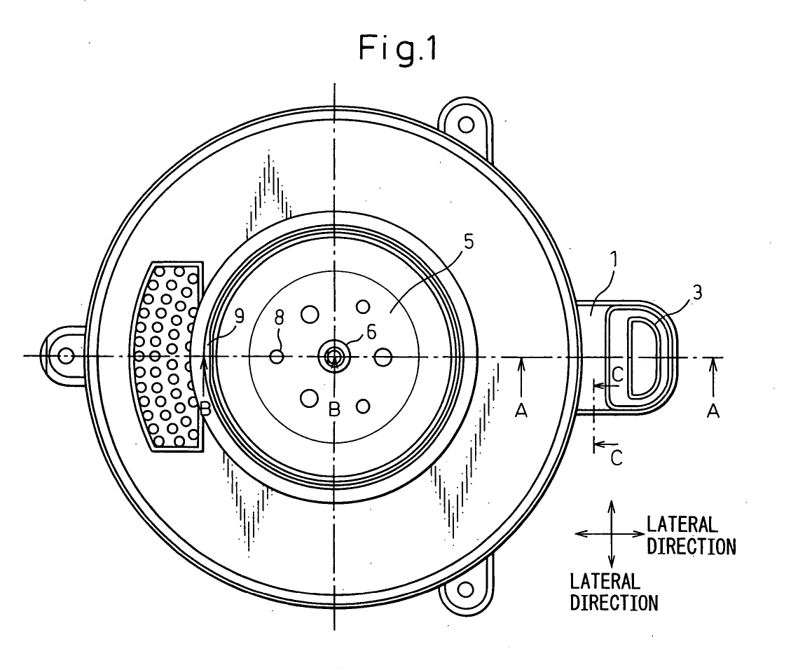

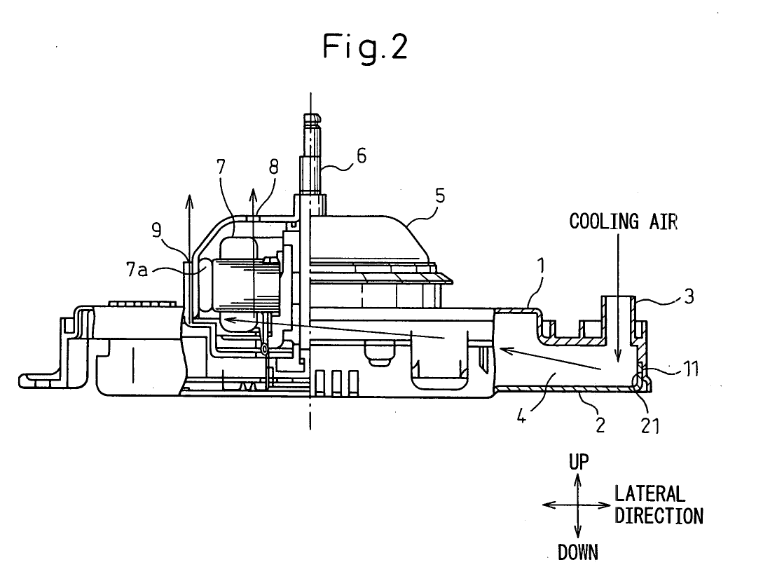

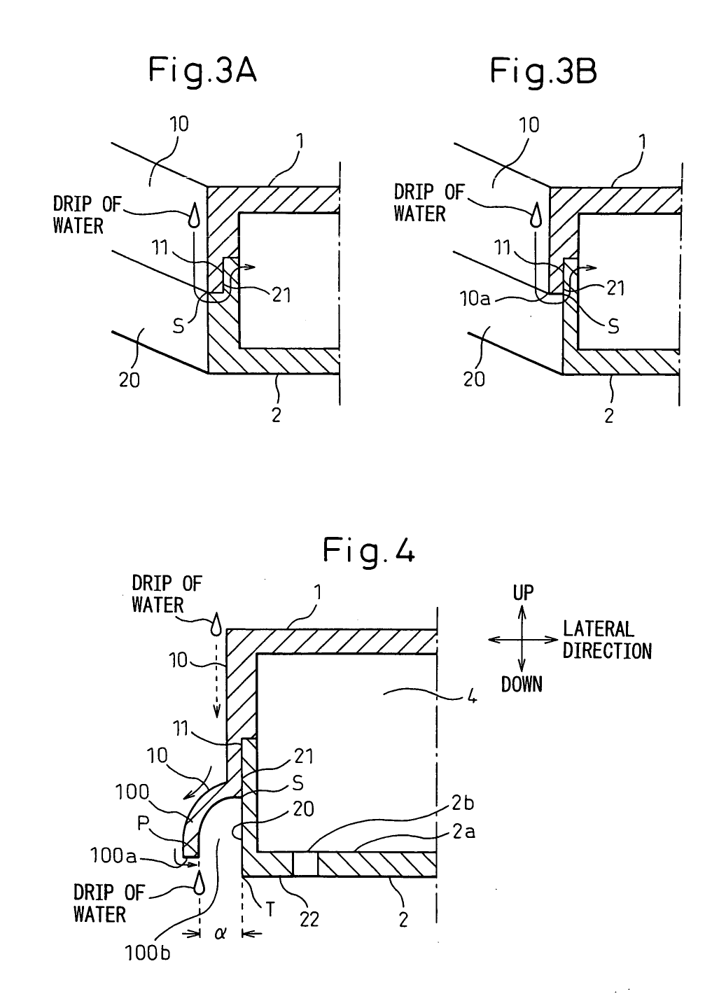

Referring to the drawings, as the first embodiment of the present invention, a motor housing for accommodating a blower motor for an air conditioning unit for vehicle use will be explained below. FIG. 1 is an upper view of the motor housing of the present embodiment. FIG. 2 is a side view. In this connection, FIG. 2 is a view showing partial sections (section A-A and section B-B) in FIG. 1. Arrows in the view show the directions as follows. An upward and downward direction shown by the arrows indicate the engaging direction of the upper case 1 and the lower case 2. Further, this upward and downward direction is made to coincide with the perpendicular direction which is an arrangement direction of the motor housing in a vehicle room.

The motor housing of the present embodiment includes an upper case 1 and a lower case 2. The upper case 1 and the lower case 2 are engaged with each other in the upward and downward direction over all the circumference of the motor housing. Inside the motor housing formed by this engagement of the upper case 1 with the lower case 2, the rotor 7 and the stator 7a, which compose the motor, and the motor drive circuit are accommodated.

A circular opening is formed in an upper portion of the upper case 1. This opening is covered with a rotor cover 5. From this rotor cover 5, a motor shaft 6 integrally rotating with the rotor 7 is protruded upward. A fan for blowing an air accommodated in a blower case not shown is rotated by this motor shaft 6.

A cooling air passage 4, the section of which is rectangular, is protruded from the outer circumferential portion of the motor housing. At a forward end portion of this cooling air passage 4, a suction port 3 for sucking a cooling air is provided on the upper case 1 side. This suction port 3 for sucking a cooling air is communicated with a discharge port of a blower case not shown in the drawing. Accordingly, as shown by the arrow in FIG. 2, air discharged from the blower case is sucked into the cooling air passage 4 in the motor housing from the suction port 3 for sucking a cooling air. In this way, a cooling air is sent into the cooling air passage 4.

This cooling air cools the drive circuit and the rotor 7 of the motor and is discharged outside the motor housing from the cooling air outlet 8 provided on the rotor cover 5 and from the cooling air outlet 9 provided between the rotor cover 5 and the upper case 1. Pressure inside the motor housing is maintained to be a negative pressure with respect to the pressure outside the motor housing by a current of cooling air which has been sucked from the suction inlet 3 for sucking a cooling air. Especially, in the cooling air passage 4 in the neighborhood of the cooling air suction port 3, a flow velocity of the sucked cooling air is high. Therefore, the generated negative pressure is also high.

FIG. 4 is a view showing a section C-C (shown in FIG. 1) which is a left half portion of the cooling air passage 4 of the first embodiment in the engaging portion of the upper case 1 with the lower case 2. In this connection, a right half portion of the cooling air passage 4 of the first embodiment is symmetrical with respect to the one-dotted chain line. Therefore, the right half portion of the cooling air passage 4 is omitted here.

In FIG. 4, sides of both the upper case 1 and the lower case 2 are provided with the outer surfaces 10, 20 which extend in the upward and downward direction. The engaging portion 11 of the upper case 1 and the engaging portion 21 of the lower case 2 are respectively formed into an L-shape and opposed to each other. In this connection, in the engaging portion of the present embodiment, the end portion of the flat side wall extending from the lower portion of the lower case 2 is defined as an engaging portion 21, and the skirt portion, the cross section of which is an L-shape, formed in one portion of the flat side wall extending from the upper portion of the upper case 1 is defined as an engaging portion 11. As a result, on the section C-C, the engaging portions 11, 21 are formed from the cooling air passage 4 side in the motor housing to the engaging end portion S on the outer surface of the lower case 2.

In this connection, the drain hole 2b is formed in the bottom portion 2a of the lower case 2. Even when water soaks into the motor housing for some reason, the water can be discharged outside the motor housing from this drain hole 2b.

On the outer surface 10 of the upper case 1, the umbrella-shaped portion 100, the thickness of which is a half of the thickness of the side wall of the upper case 1 (the thickness of which is approximately the same as the thickness of the side wall of the lower case 2), is formed in such a manner the umbrella-shaped portion 100 swells in the lateral direction on the opposite side to the outer surface 20 of the lower case 2 as the umbrella-shaped portion 100 extends downward from the position of the engaging end portion S. Between this umbrella-shaped portion 100 and the outer surface 20 of the lower case 2, the gap 100b is formed, the gap size of which is increased as the umbrella-shaped portion 100 extends downward, and this umbrella-shaped portion 100 is a skirt portion of the lower end portion of the upper case 1. This umbrella-shaped portion 100 extends downward to an upper position of the lower surface 22 of the lower case 2.

The lower end portion of the umbrella-shaped portion 100, which is a lower end portion of the upper case 1, can be formed into an arbitrary shape. In the first embodiment of the present invention, the surface 100a is formed in the lateral direction for the lower end position of the umbrella-shaped portion 100. When water drips down on the outer surface 10 of the upper case 1 constructed as described above, the water, which has reached a lower end portion of the umbrella-shaped portion 100, moves on the lower face 100a of the umbrella-shaped portion 100 in the lateral direction (to the right in FIG. 4) due to surface tension and arrives at the point P which is the closest to the outer surface 20 of the lower case 2 located in the lateral direction at a distance of the gap 100b. When the gap 100b is relatively large, the water cannot move any more in the lateral direction to the lower case 2 side. Then, the water perpendicularly drips downward from a portion (a dripping end portion) on the lower face 100a of the lower end portion of the umbrella-shaped portion 100.

In this connection, in the present embodiment, the position P, which can be a dripping position of water and is located at a position closest to the outer surface 20 of the lower case, is defined as a dripping end portion of water. That is, between the dripping end portion P, which is formed in the lower end portion of the umbrella-shaped portion 100 as the lower end portion of the upper case 1, and the outer surface 20 of the lower case 2, the gap 100b, the maximum distance in the lateral direction (the maximum gap size) of which is α, is formed.

However, as long as water drips from the lower end portion surface 100a of the umbrella-shaped portion 100, any portion may be the dripping end portion P. That is, the lower end portion of the umbrella-shaped portion 100 may not be a surface-shape but a protrusion-shape such as a semicircle. In this case, the dripping end portion P is the lowest position of this protruding shape. In any shape, the distance α in the lateral direction between the dripping end portion P and the outer surface 20 of the side of the lower case 2 is the maximum gap.

When water cannot move from the dripping end portion P to the outer surface 20 of the lower case 2 because of the existence of the gap 100b, the water cannot move to the engaging end portion S which is located at an upper position of the dripping end portion P on the outer surface 20 of the lower case 2. Since the water cannot move from the neighborhood of the dripping end portion P, it drips downward from this dripping end portion P. Accordingly, no capillary phenomenon is generated, and water is not sucked into the motor housing.

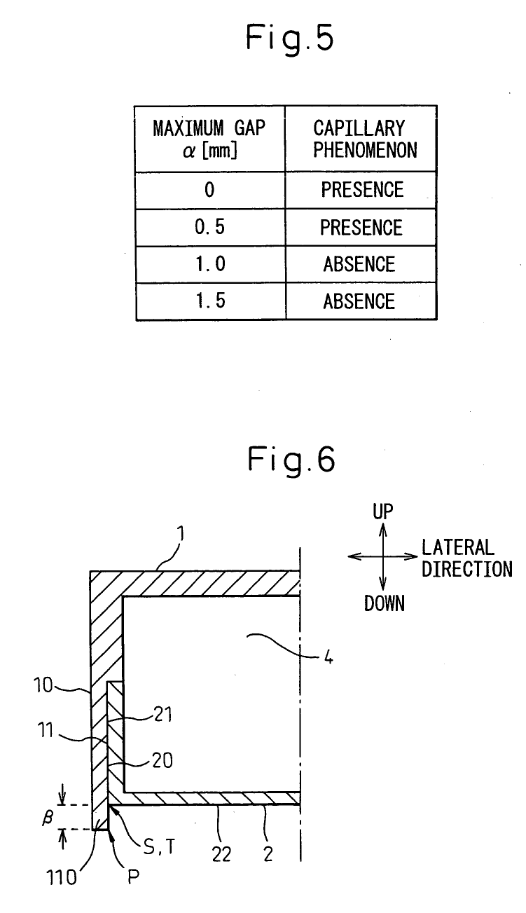

FIG. 5 is a table showing whether or not water dripping on the outer surface 10 of the upper case 1 finally gets into the cooling air passage 4 in the motor housing from the engaging end portion S by the phenomenon of capillary when the maximum gap a is variously changed.

As a result, the following can be concluded. When the maximum gap α is not less than 1.0 mm, no capillary phenomenon is generated. When the maximum gap α is smaller than 1.0 mm, the capillary phenomenon is generated. That is, when the maximum gap α is not less than 1.0 mm, no water moves from the dripping end portion P to the outer surface 20 of the lower case 2. Accordingly, no capillary phenomenon is generated in the engaging end portion S.

In the case where the maximum gap α is smaller than 1.0 mm (α=0.5 mm or α=0 mm), water moves from the dripping end portion P via the gap 100b, which is relatively small (the maximum gap α), to the outer surface 20 of the lower case 2 and is interposed in the gap 100b. The water, which is interposed in the gap 100b, moves upward in this gap 100b by the capillary phenomenon and further moves to the engaging end portion S. The water, which has arrived at the engaging end portion S, is sucked from the engaging end portion S into the motor housing by the phenomenon of capillary. In this connection, in the case where the maximum gap α is small in this way, the dripping end portion P of the lower end portion of the upper case 1 and the portion on the outer surface 20 of the lower case 2 located close to this dripping end portion P can be assumed to be a substantial engaging end portion S.

As described above, according to the first embodiment, in the case where the upward and downward direction of the motor housing is arranged in the perpendicular direction, the engaging end portion S, which is located on the outer surface of the lower case 2, and the dripping end portion P, which is a portion from which water drips down from the upper case 1 in the gravity direction on the outer surface 10 of the upper case 1, are separated from each other by not less than a predetermined distance (1 mm). Therefore, it is possible to prevent water from moving in the lateral direction from the dripping end portion P to the engaging end portion S. Accordingly, it is possible to prevent water being sucked from the engaging end portion S into the inside of the lower case 2, that is, into the motor housing, via the engaging portion of the upper case and the lower case by the capillary phenomenon.

Next, another embodiment will be explained below. In this connection, each embodiment described below is different from the first embodiment described above only in the sectional shape of the engaging portion in which the upper case 1 and the lower case 2 are engaged with each other. Therefore, the following embodiments will be explained referring to the sectional view taken on line C-C in the neighborhood of the cooling air passage 4 which is the same as that of the first embodiment. In this connection, similar parts are indicated by like reference characters in the first embodiment described above and the embodiments described as follows, and the explanations are omitted here.

Next, the second embodiment will be explained as follows. FIG. 6 is a sectional view showing a section of the engaging portion in the neighborhood of the cooling air passage 4 of the motor housing of the second embodiment. In the second embodiment, the outer surface 10 of the upper case 1 is extended straight downward as it is. That is, the lower end portion 110 of the upper case 1 is extended downward to a position lower than the lower surface 22 of the lower case 2 by the distance β. Accordingly, in the second embodiment, the dripping end portion P formed in the lower end portion of the upper case 1 is located at a position lower than the position of the lower surface 22 of the lower case 2 or lower than the lower end portion T of the side of the lower case 2 by the distance β. In this case, β is referred to as a lower distance β. As the outer surface 10 of the upper case 1 is arranged along the outer surface 20 of the lower case 2, all the outer surface 20 of the lower case 2 becomes the engaging portion 21. Accordingly, the lower end portion T of the outer surface of the lower case 2 coincides with the engaging end portion S.

According to the second embodiment, water drips down on the outer surface 10 of the upper case 1 and reaches the dripping end portion P formed in the lower end portion 110 of the upper case 1. However, as the dripping end portion P is located at a position lower than the engaging end portion S, that is, the lower end portion T on the side of the lower case 2, water cannot move to the engaging end portion S which is located at a position higher than the dripping end portion P in the perpendicular direction. Accordingly, water can be prevented from being sucked from the engaging end portion S into the motor housing by the capillary phenomenon.

As described above, according to the second embodiment, the movement of water from the dripping end portion P to the engaging end portion S is prevented not by the gap (the skirt portion) provided in the lower end portion of the upper case 1 for preventing water from moving in the lateral direction as shown in the first embodiment but by the arrangement of the dripping end portion P which is located at a position lower than the engaging end portion S or the lower end portion T of the side of the lower case 2.

In this connection, in the second embodiment, when the lower distance β from the engaging end portion S or the lower end portion T of the side of the lower case 2 to the dripping end portion P is longer than 0 (β>0), that is, when the dripping end portion P is located at a position a little lower in the perpendicular direction than the engaging end portion S or the lower end portion T of the side of the lower case 2, water can be prevented from moving upward.

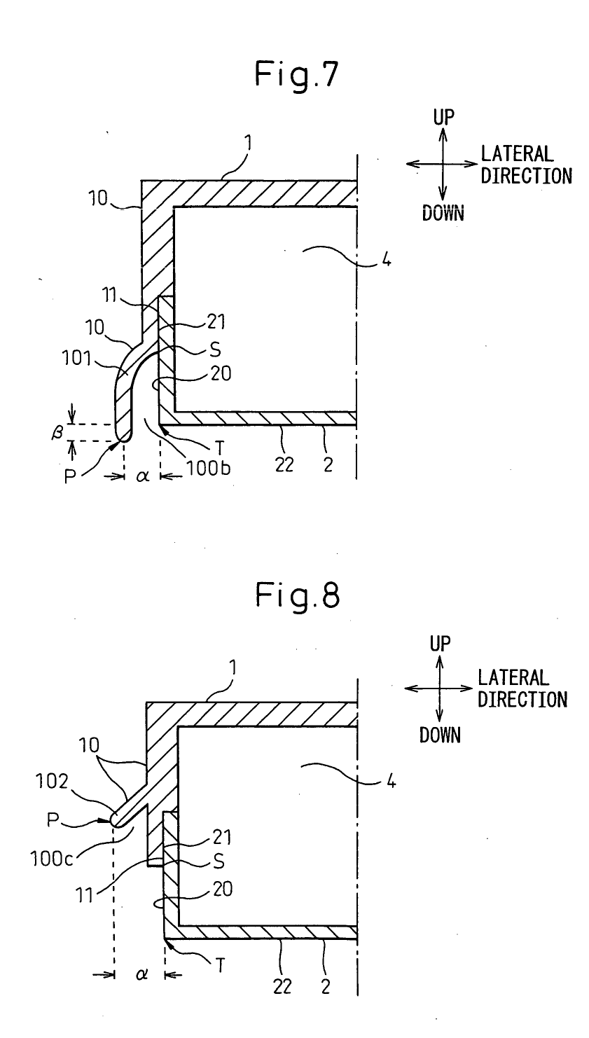

Next, the third embodiment will be explained below. FIG. 7 is a sectional view showing a section of the engaging portion in the neighborhood of the cooling air passage 4 of the motor housing of the third embodiment. In the third embodiment, the umbrella-shaped portion 100 formed at the lower end portion of the upper case 1 of the first embodiment is extended to a position lower than the lower side surface 22 of the lower case 2 so as to form the umbrella-shaped portion 101. Due to the foregoing, the dripping end portion P formed at the lower end portion of the umbrella-shaped portion 101 is separated from the outer surface 20 (the lower end portion T of the outer surface 20) of the side of the lower case 2 in the lateral direction by the maximum gap α (α>1 mm) via the gap 100b. Further, the dripping end portion P is located at a position lower than the lower side surface 22 of the lower case 2 by the distance β.

That is, according to the third embodiment, water is prevented from moving from the dripping end portion P to the lower case 2 side by the distance α in the lateral direction which is provided by the gap 100b in the same manner as that of the first embodiment. Water is also prevented from moving from the dripping end portion P to the lower case 2 side by the lower distance β in the same manner as that of the second embodiment.

Due to the foregoing, after water drips down on the outer surface of the upper case 1, it arrives at the dripping end portion P formed at the lower end of the umbrella-shaped portion 101. After that, the water cannot move from the dripping end portion P in the lateral direction. Further, the water cannot move to the lower end portion T of the side 20 of the lower case 2 which is located at a position higher than the dripping end portion P in the perpendicular direction. Thus, the water drips downward from the dripping end portion P in the perpendicular direction.

Therefore, according to the third embodiment, the water dripping down on the outer surface 10 of the upper case 1 is prevented from moving upward to the gap 100b by the capillary phenomenon. Further, the water cannot move to the engaging end portion S located at a higher position in the gap 100b. Accordingly, it is impossible for the water from soaking into the motor housing from the engaging end portion S by the capillary phenomenon.

Next, the fourth embodiment will be explained below. FIG. 8 is a sectional view showing a section of the engaging portion in the neighborhood of the cooling air passage 4 of the motor housing of the fourth embodiment. In the fourth embodiment, a protruding portion, which protrudes in the opposite direction to the lower case 2 in the lateral direction, is formed at a position on the outer surface 10 of the upper case 1 which is higher than the lower end portion of the outer surface 10 of the upper case 1 extending downward in the perpendicular direction.

On the outer surface 10 of the upper case 1, the umbrella-shaped portion 102 is formed which extends in the oblique lower direction by a predetermined length. In this umbrella-shaped portion 102, the dripping end portion P corresponds to the lower end portion of the umbrella-shaped portion 102 and is separated from the side 20 of the lower case 2, that is, separated from the engaging end portion S in the lateral direction by the distance α. Between this dripping end portion P and the side 20 of the lower case 2, the skirt portion 100c and the engaging portion 11 of the lower end portion of the upper case 1 are arranged. After water has arrived at the dripping end portion P, the water cannot move in the lateral direction, that is, the water cannot move to the lower case 2 side in the same manner as that of the first embodiment described above because this skirt portion 100c exists. Therefore, the water drips downward in the perpendicular direction from the dripping end portion P.

Due to the foregoing, in the fourth embodiment, water dripping on the outer surface 10 of the upper case 1 can be prevented from moving in the lateral direction from the dripping end portion P of the lower end portion of the umbrella-shaped portion 102, that is, water dripping on the outer surface 10 of the upper case 1 can be prevented from moving to the side 20 of the lower case 2 and the engaging end portion S located on the side 20 of the lower case 2. Accordingly, water can be prevented from entering the motor housing by the capillary phenomenon.

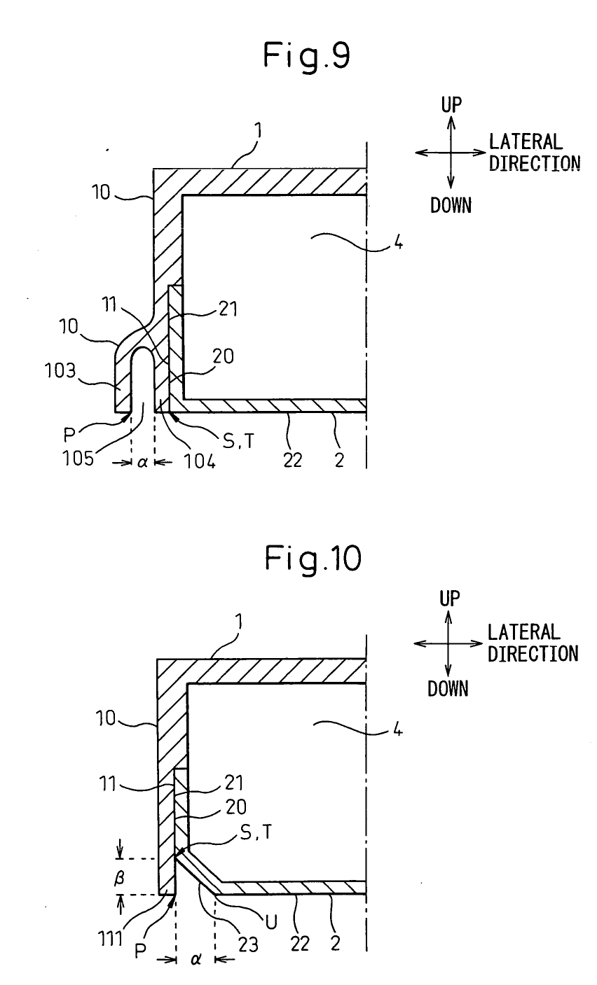

Next, the fifth embodiment will be explained below. FIG. 9 is a sectional view showing a section of the engaging portion in the neighborhood of the cooling air passage 4 of the motor housing of the fifth embodiment. In the fifth embodiment, the umbrella-shaped portion 103, which is formed in the same manner as that of the first and the third embodiment, is provided in the lower end portion of the case 1. Between this the umbrella-shaped portion 103 and the side 20 of the lower case 2, the upper case 1 is extended downward in the upward and downward direction, so that the lower end portion 104 of the lower case 1 can be formed. This lower end portion 104 is used as the engaging portion 11 and engaged with the engaging portion 21 of the side 20 of the lower case 2. Due to the foregoing, the lower end portion T of the side 20 of the lower case 2 corresponds to the engaging end portion S. In this connection, in this fifth embodiment, the lower distance β of the lower end portion of the umbrella-shaped portion 103 is 0, that is, a position of the lower end portion of the umbrella-shaped portion 103 in the upward and downward direction is the same as the lower side surface 22 of the lower case 2.

In the lower end portion of the upper case 1, between the umbrella-shaped portion 103 and the side 20 of the lower case 2, the skirt portion 105, the cross section of which is a U-shape, is formed. In the lower end portion of the umbrella-shaped portion 103, when the end portion of the lower case 2 side is assumed to be the dripping end portion P, the size of this skirt portion 105 in the lateral direction can be the gap distance α (α>1 mm) between the dripping end portion P and the end portion of the lower end portion 104 of the upper case 1 on the dripping end portion P side. By this gap distance α, in the same manner as that of the first embodiment described before, water can be prevented from moving in the lateral direction from the dripping end portion P.

As described above, according to the fifth embodiment, by the gap formed in this skirt portion 105, after water has dripped on the outer surface 10 of the upper case 1 and arrives at the dripping end portion P, the movement in the lateral direction can be prevented, that is, the water is prevented from moving to the lower end portion T of the side 20 of the lower case 2 and the engaging end portion S located on the side 20. Therefore, water can be prevented from entering the motor housing by the capillary phenomenon.

Next, the sixth embodiment will be explained below. FIG. 10 is a sectional view showing a section of the engaging portion in the neighborhood of the cooling air passage 4 of the motor housing of the sixth embodiment. In the sixth embodiment, in the same manner as that of the second embodiment described before, the outer surface 10 of the upper case 1 is extended downward in the perpendicular direction, and the lower position β of the lower end portion 111 of the upper case 1 is 0, that is, the lower position P of the lower end portion 111 of the upper case 1 is the same as the lower surface 22 of the lower case 2.

In this sixth embodiment, the tapered face 23 is formed in the crossing portion in which the side 20 of the lower case 2 and the lower surface 22 cross each other. One end of this tapered face 23 is the lower end portion T of the side 20 of the lower case 2 and located at a position higher than the lower surface 22 of the lower case 2 by the distance β (β>0). The engaging portions 11, 21, in which the upper case 1 and the lower case 2 are engaged with each other, are formed to this lower end portion T. That is, the lower end portion T and the engaging end portion S coincide with each other.

The other end portion of the tapered face 23 is the end portion U of the lower side surface 22 of the lower case 2 in the lateral direction. This end portion of the tapered face 23 is located at a position on the opposite side to the upper case 1 with respect to the side 20 of the lower case 2 in the lateral direction by the distance α (α>1 mm).

The dripping end portion P in the lower end portion 11 of the upper case 1 is assumed to be located at the end of the lower end portion 111 on the lower case 2 side. This dripping end portion P is located at a position lower than the lower end portion T of the side 20 of the lower case 2, that is, this dripping end portion P is located at a position of the lower distance β from the engaging end portion S. Therefore, in the same manner as that of the second embodiment, the movement of water to the engaging end portion S, which is located in an upper portion of the dripping end portion P in the perpendicular direction, can be prevented.

The dripping end portion P is located at a position distant from the end portion U of the lower side 20 of the lower case 2 in the lateral direction by the gap distance α. Therefore, in the same manner as that of the first embodiment described before, the movement of water from the dripping end portion P to the end portion U of the lower side 20 in the lateral direction can be prevented. As a result, the movement of water from the dripping end portion P to the end portion U of the lower side 20 in the lateral direction can be prevented in the same manner as that of the first embodiment. As a result, the movement of water between the lower end portion 111 of the upper case 1 and the tapered face 23 caused by the capillary phenomenon can be prevented.

As described above, according to the sixth embodiment, after water has dripped down on the outer surface 10 of the upper case 1 and arrived at the dripping end portion P, the water is prevented from moving upward in the perpendicular direction by the tapered face 23 provided at the lower end portion of the lower case 2, that is, the water is prevented from moving to the lower end portion T (the engaging end portion S) of the side 20 of the lower case 2. At the same time, the water is prevented from moving in the lateral direction, that is, the water is prevented from moving to the end portion U of the lower surface 22 of the lower case 2 in the lateral direction. Therefore, the water is prevented from entering the motor housing from the engaging end portion S by the capillary phenomenon.

In this connection, in the sixth embodiment, the tapered face 23 is provided in the lower end portion of the lower case 2. However, it should be noted that the surface to be formed in the lower end portion of the lower case 2 is not limited to the tapered face 23. That is, the corner portion may be chamfered, and the engaging end portion S is located at a position higher than the lower surface 22 of the lower case 2 by the upper distance β, and the end portion U of the lower surface 22 of the lower case 2 in the lateral direction can be located at a position distant from the lower end portion 111 of the upper case 1 by the distance α.

Next, the seventh embodiment will be explained below. FIG. 11 is a sectional view showing a section of the engaging portion in the neighborhood of the cooling air passage 4 of the motor housing of the seventh embodiment. In the seventh embodiment, in order to generate the lateral direction distance α and the lower distance β between the dripping end portion P and the engaging end portion S, the tapered face 112a is provided in the lower end face 112 of the upper case 1.

That is, the lower end portion T of the side 20 of the lower case 2 is made to coincide with the end portion of the lower surface 22 of the lower case 2. The outer side 10 of the upper case 1 is extended in the upward and downward direction, and the lower end portion 112 of the outer side 10 is made to coincide with the position of the lower surface 22 of the lower case 2 in the upward and downward direction. In the lower end portion 112 of the upper case 1, the tapered face 112a is provided so that the gap distance α (α>1 mm) between the lower end portion 112 and the side 20 of the lower case 2 can be maximized in the lowermost portion in the upward and downward direction.

A lower end portion of the tapered face 112a is the dripping end portion P formed at the lowermost portion of the upper case 1. An upper end portion of the tapered face 112a is located at a position higher than the dripping end portion P by the distance β and forms the lower end portion of the engaging portion 11 engaged with the side 20 of the lower case 2, that is, the upper end portion of the tapered face 112a forms the engaging end portion S.

As described above, according to the seventh embodiment, after water has dripped down on the outer surface 10 of the upper case 1 and arrived at the dripping end portion P, the water is prevented from moving upward in the perpendicular direction by the tapered face 112a provided in the lower end portion 112 of the upper case 1, that is, the water is prevented from moving to the engaging end portion S. At the same time, the water is prevented from moving in the lateral direction, that is, the water is prevented from moving onto the side 20 of the lower case 2. Therefore, the water is prevented from entering the motor housing from the engaging end portion S by the capillary phenomenon.

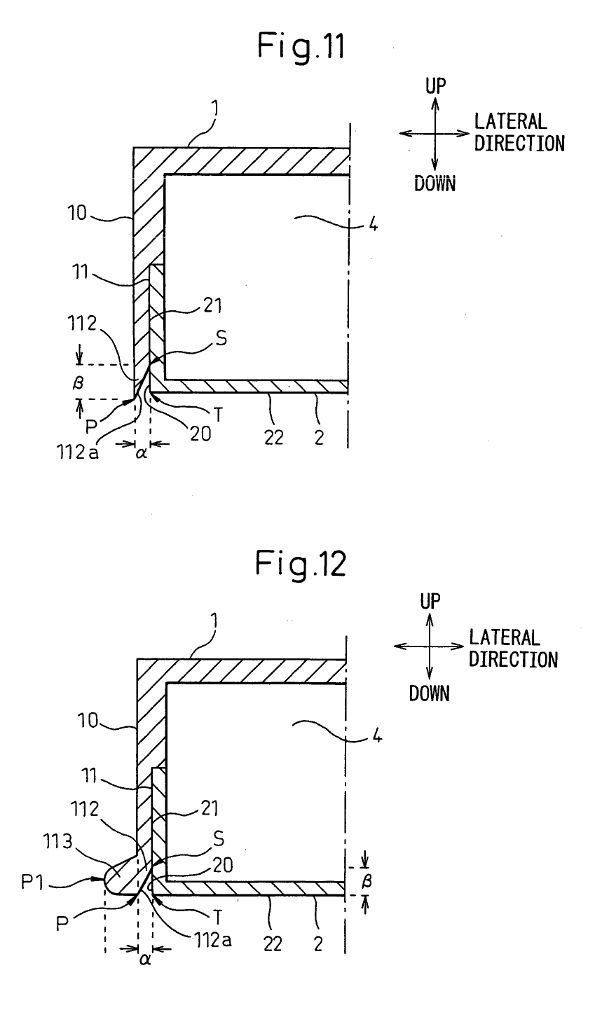

Next, the eighth embodiment will be explained below. FIG. 12 is a sectional view showing a section of the engaging portion in the neighborhood of the cooling air passage 4 of the motor housing of the eighth embodiment. In the eighth embodiment, the protruding portion 113 is provided in the lower end portion 112 of the upper case 1 in the seventh embodiment described before.

In the eighth embodiment, in the lower end portion 113 of the upper case 1, at the lowermost portion of the outer surface 10 of the upper case 1 extending in the upward and downward direction, a swelling portion is formed which protrudes in the lateral direction on the opposite side to the lower case 2. In this connection, between the lower end portion 113 of the upper case 1 and the side 20 of the lower case 2, the same tapered face 112a as that of the seventh embodiment is provided. By this tapered face 112a, the skirt portion is formed which has the maximum gap α in the lateral direction and the distance β from the lower surface 22 of the lower case 2 to the engaging end portion S in the upward and downward direction.

Since the motor housing according to the eighth embodiment is constructed as described above, when water drips down on the outer surface 10 of the upper case 1 and arrives at the protruding portion 113, in the case of drips of water of a large size, water drips downward from the dripping end portion of the forward end portion P1 of the protruding portion 113 in the lateral direction. Alternatively, in the case of drips of water of a small size, water flows to the lower surface along the outer surface of the protruding portion 113 and moves in the lateral direction, and the water reaches a lower end portion of the tapered face 112a. Since the water cannot move anymore in the lateral direction, the water drips downward from the dripping end portion P of this lower end portion.

As described above, in the eighth embodiment, any portion on the lower side of the protruding portion 113 provided in the lower end portion of the upper case 1 can be the dripping end portion P, and water drips downward from this dripping end portion P. Accordingly, the movement of water in the direction of the engaging end portion S can be prevented, that is, the movement of water in the lateral direction and the upward direction can be prevented. Accordingly, it is possible to prevent water from soaking into the motor housing from the engaging end portion S by the capillary phenomenon.

Finally, another embodiment will be explained below. In each embodiment described above, the engaging portions 11, 21 of the upper case 1 and the lower case 2 are engaged with each other in such a manner that the lower end portion of the upper case 1, in which an L-shaped skirt portion is formed, is engaged with the upper end portion of the side 20 of the lower case 2 extending in the upward and downward direction. However, it should be noted that the present invention is not limited to the above specific embodiment.

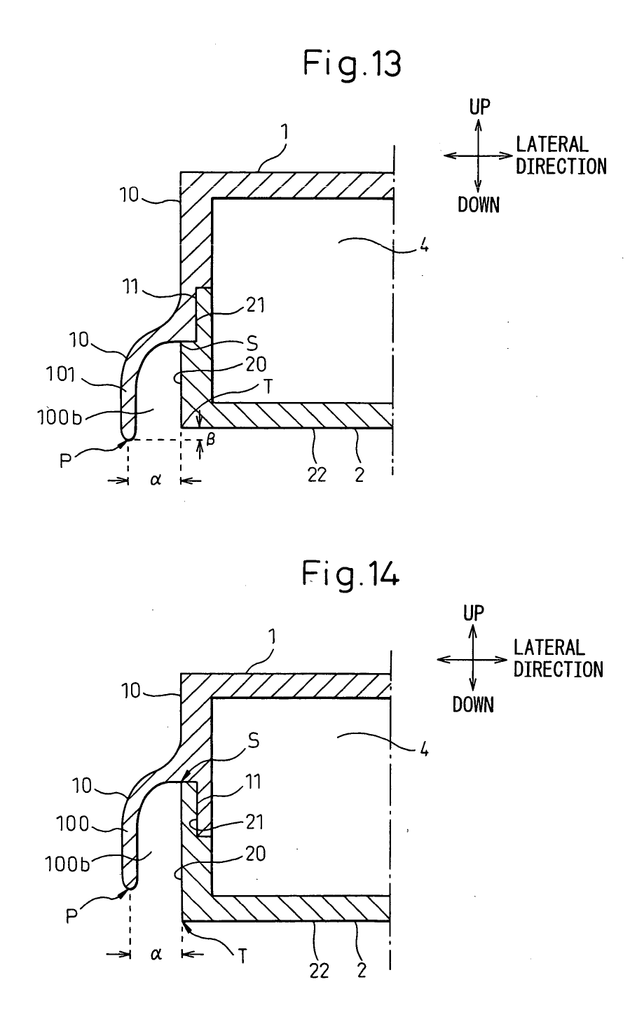

For example, as shown in FIG. 13, the L-shaped skirt portion may be provided in an upper end portion of the lower case 2 and engaged with the L-shaped skirt portion of the lower end portion of the upper case 1. In this case, the lower end portion of the engaging portion 11, 21 formed on the side 20 of the lower case 2 corresponds to the engaging end portion S. In the example shown in FIG. 13, when the same umbrella-shaped portion 101 as that of the third embodiment (shown in FIG. 7) is provided in the lower end portion of the upper case 1, the intrusion of water from the engaging end portion S into the motor housing by the capillary phenomenon can be prevented.

As shown in FIG. 14, the following structure may be adopted. The forming direction of the L-shaped skirt portion of each of the engaging portions 11, 21 is reversed from that of the example shown in FIG. 13, and the upper end portions of the engaging portions 11, 21 formed on the side 20 of the lower case 2 are made to correspond to the engaging end portion S. In this connection, in the example shown in FIG. 14, when the same umbrella-shaped portion 100 as that of the first embodiment (shown in FIG. 4) is provided in the lower end portion of the upper case 1, the intrusion of water from the engaging end portion S into the motor housing by the capillary phenomenon can be prevented.

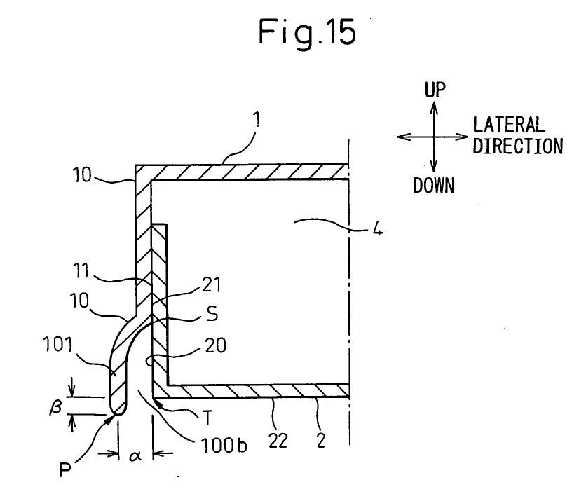

Further, as shown in FIG. 15, the following structure may be adopted. The engaging portions 11, 21 are not provided with a skirt portion, and the upper case 1 extending in the upward and downward direction is engaged from the outside with the side 20 of the lower case 2 extending in the upward and downward direction. In this structure, the engaging end portion S corresponds to the lower end portions of the engaging portions 11, 21 extending in the upward and downward direction. In the example shown in FIG. 15, when the same umbrella-shaped portion 101 as that of the third embodiment (shown in FIG. 7) is provided in the lower end portion of the upper case 1, the intrusion of water from the engaging end portion S into the motor housing by the capillary phenomenon can be prevented.

In each embodiment described above, the present invention is applied to a motor housing for accommodating a blower motor of an air conditioning unit for vehicle use. However, it should be noted that the present invention is not limited to the above specific embodiment.

As long as it agrees with the concept of the present invention described in the scope of claim, any variation is included in the present invention. The present invention is not limited to the above specific embodiments.

While the invention has been described by reference to specific embodiments chosen for purposes of illustration, it should be apparent the numerous modifications could be made thereto by those skilled in the art without departing from the basic concept and scope of the invention.

1. A motor housing comprising an upper case (1) and a lower case (2) which are engaged with each other by the respective engaging portions (11, 21), the motor housing accommodating a motor (7, 7a) inside, wherein
a positional relation between an engaging end portion (S) located on a side (20) which is an outer surface of the lower case in the upward and downward direction and a dripping end portion (P) located at a lower end portion (100, 101, 102, 103, 110, 111, 112, 113) of an outer surface of the upper case which is a portion, from which water drips down, on the upper surface of the upper case is established so that at least one of the distance (α) in the lateral direction perpendicular to the upward and downward direction from the dripping end portion and the side of the lower case and the distance (β) in the upward and downward direction from the dripping end portion to the engaging end portion can be not less than a predetermined value.

2. A motor housing according to claim 1, wherein a skirt portion (100b, 100c, 105) having an opening, the length in the lateral direction of which is a predetermined value, is formed at the lower end portion of the upper case.

3. A motor housing according to claim 1, wherein a protruding portion (100, 101, 102, 103) protruding in the opposite direction to the lower case is formed in the lower end portion of the upper case in the lateral direction, and the dripping end portion is located on a surface of the protruding portion.

4. A motor housing according to claim 1, wherein an umbrella-shaped portion (102) extending in an oblique downward direction with respect to the upward and downward direction by a predetermined length is formed on an outer surface of the upper case on the opposite side to the lower case.

5. A motor housing according to claim 1, wherein a tapered portion (112a), the distance in the lateral direction from the side of the lower case of which is increased as it comes in the downward direction, is formed in the lower end portion (112) of the upper case, and the dripping end portion is a lower end portion of the tapered portion in the upward and downward direction.

6. A motor housing according to claim 1, wherein a lower end portion (T) of the side (20) of the lower case in the upward and downward direction is located at an upper position of the lower surface (22) of the lower case in the upward and downward direction.

7. A motor housing according to claim 1, wherein a gap (100b, 100c, 105) of a predetermined length (α) is formed in the lateral direction between the lower end portion of the upper case and the side of the lower case.

8. A motor housing according to claim 1, wherein the predetermined value of the distance from the dripping end portion to the side of the lower case in the lateral direction is 1 mm.

9. A motor housing according to claim 1, wherein the dripping end portion is located at a lower position of the engaging end portion in the upward and downward direction.

10. A motor housing according to claim 1, wherein the lower end portion of the upper case is located at a position lower than the lower end portion of the side of the lower case in the upward and downward direction.

11. A motor housing according to claim 1, wherein a drain hole (2b) is formed in the lower bottom portion (2a) of the lower case in the upward and downward direction.

12. A motor housing according to claim 1, wherein cooling air flows into the motor housing.
